(19) United States
(12) Patent Application Publication
(10) Pub. No.: US 2013/0199189 A1
(43) Pub. Date: Aug. 8, 2013

(54) FUEL INJECTION ASSEMBLY FOR USE IN TURBINE ENGINES AND METHOD OF ASSEMBLING SAME

(71) Applicants: Jong Ho Uhm, Simpsonville, SC (US); Thomas Edward Johnson, Greer, SC (US)

(72) Inventors: Jong Ho Uhm, Simpsonville, SC (US); Thomas Edward Johnson, Greer, SC (US)

(21) Appl. No.: 13/368,658

(22) Filed: Feb. 8, 2012

(51) Int. Cl. F02C 7/22; B23P 11/00

(52) U.S. Cl. 60/737; 137/15.01

(57) ABSTRACT

A fuel injection assembly for use in a turbine engine is provided. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within a combustor and/or reducing NOx emission within the combustor during operation of the turbine engine.

### FEDERAL RESEARCH STATEMENT

This invention was made with Government support under Contract No. DE-FC26-05NT42643, awarded by the Department of Energy (DOE), and the Government has certain rights in this invention.

### BACKGROUND OF THE INVENTION

The subject matter disclosed herein generally relates to turbine engines and, more particularly, to a fuel injection assembly for use in a turbine engine.

At least some known turbine engines are used in cogeneration facilities and power plants. Such engines may have high specific work and power per unit mass flow requirements. To increase the operating efficiency, at least some known turbine engines, such as gas turbine engines, operate with increased combustion temperatures. In at least some known gas turbine engines, engine efficiency increases as combustion gas temperatures increase.

However, operating with higher temperatures may also increase the generation of polluting emissions, such as oxides of nitrogen (NOₓ). In an attempt to reduce the generation of such emissions, at least some known turbine engines include improved combustion system designs. For example, many combustion systems may use premixing technology that includes tube assemblies or micro-mixers that facilitate mixing substances, such as diluents, gases, and/or air with fuel to generate a fuel mixture for combustion. Premixing technology may also include a process known as hydrogen doping. In a hydrogen doping process, hydrogen gas (H₂) is mixed with fuel such that a fuel and hydrogen gas mixture is channeled to the tube assemblies. Hydrogen doping has been shown to reduce emission levels and helps reduce a combustor lean blow out (LBO).

However, operating with high hydrogen gas levels may actually increase NOₓ levels and/or may induce a screech tone frequency of greater than 1 kHz. Such a screech frequency range may result in a flame behavior that causes a coupling interaction between the nozzles and/or between components, such as tubes, of the nozzle within the combustion assembly. Such flame behavior may substantially increase the temperature within the combustion assembly and/or may induce vibrations throughout the combustion assembly and associated hardware components. Moreover, increased temperatures and the vibrations induced into the combustion system may increase the wear of the combustor and associated components, and/or may shorten the useful life of the combustion system.

### BRIEF DESCRIPTION OF THE INVENTION

In one embodiment, a fuel injection assembly for use in a turbine engine is provided. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within a combustor and/or reducing NOx emission within the combustor during operation of the turbine engine.

In another embodiment, a turbine engine is provided. The turbine engine includes a compressor and a combustion assembly coupled downstream from the compressor. The combustion assembly includes at least one combustor that includes at least one fuel injection assembly. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within the combustor and/or reducing NOx emission within the combustor during operation of the turbine engine.

In yet another embodiment, a method of assembling a fuel injection assembly for use with a turbine engine is provided. A plurality of tube assemblies are provided. Each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within a combustor and/or reducing NOx emission within the combustor during operation of the turbine engine.

### BRIEF DESCRIPTION OF THE DRAWINGS

FIG. 1 is a schematic cross-sectional view of an exemplary turbine engine;

FIG. 2 is a schematic cross-sectional view of a portion of an exemplary fuel injection assembly that may be used with the turbine engine shown in FIG. 1 and taken along area 2;

FIG. 3 is an enlarged schematic cross-sectional view of a portion of an exemplary injection system that may be used with the fuel injection assembly shown in FIG. 2 and taken along area 3; and

FIG. 4 is an enlarged schematic cross-sectional view of a portion of an alternative injection system that may be used with the fuel injection assembly shown in FIG. 2 and taken along area 4.

### DETAILED DESCRIPTION OF THE INVENTION

The exemplary apparatus, systems, and methods described herein overcome at least some known disadvantages associated with at least some known combustion systems of turbine engines that operate with higher temperatures. The embodiments described herein provide a fuel injection assembly that may be used with turbine engines to facilitate substantially reducing the dynamic pressure oscillations and/or reducing NOx emission within a combustor. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within a combustor and/or reducing NOx emission within the combustor during operation of the turbine engine. By delivering the fluid toward at least one of the tube assemblies, flame interactions within/or between the tube assemblies may be prevented, and the dynamic pressure oscillations and/or locally peak temperature may be reduced therein. Such a reduction in temperature may also facilitate a reduction in the production of NOx emission by the turbine engine.

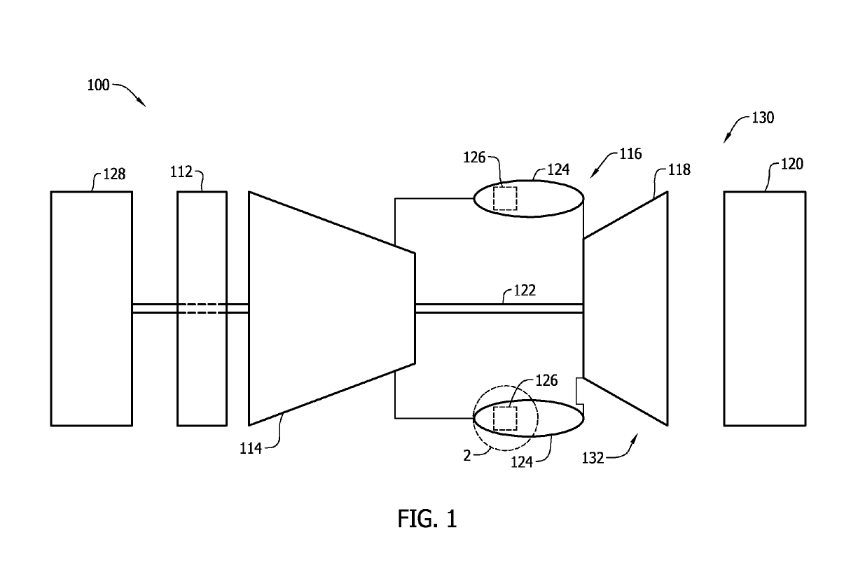

FIG. 1 is a schematic cross-sectional view of an exemplary turbine engine 100. More specifically, turbine engine 100 is a gas turbine engine. While the exemplary embodiment includes a gas turbine engine, the present invention is not limited to any one particular engine, and one of ordinary skill in the art will appreciate that the current invention may be used in connection with other turbine engines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is positioned in flow communication with the compressor section 114. A fuel injection assembly 126 is coupled within each combustor 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132.

During operation, intake section 112 channels air towards compressor section 114 wherein the air is compressed to a higher pressure and temperature prior to being discharged towards combustor section 116. The compressed air is mixed with fuel and other fluids that are provided by each fuel injection assembly 126 and ignited to generate combustion gases that are channeled towards turbine section 118. More specifically, each fuel injection assembly 126 injects fuel, such as natural gas and/or fuel oil, air, diluents, and/or Nitrogen gas (N₂) in respective combustors 124, and into the air flow. The blended mixtures are ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132. By having each fuel injection assembly 126 inject the fuel with air, diluents, and N₂ in respective combustors 124, dynamic pressure oscillations and the temperature may be reduced within each combustor 124. Such a reduction in temperature may also facilitate a reduction in the production of oxides of nitrogen (NOₓ) by turbine engine 100.

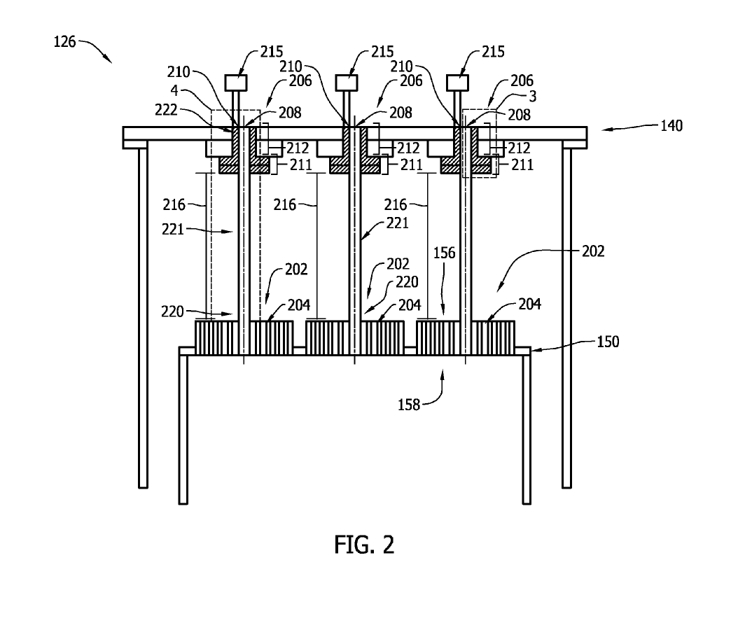

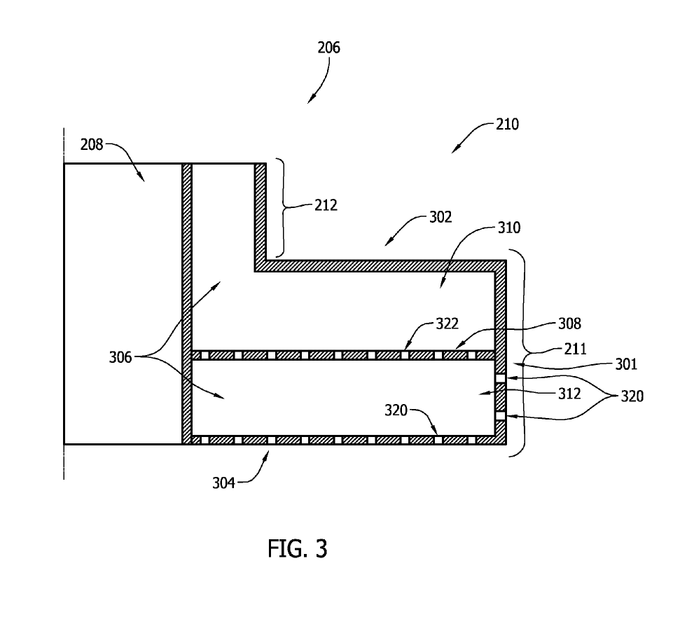

FIG. 2 is a cross-sectional view of a portion of fuel injection assembly 126 and taken along area 2 (shown in FIG. 1). FIG. 3 is an enlarged schematic cross-sectional view of a portion of injection system 206 and taken along area 3 (shown in FIG. 2). Referring to FIG. 2, in the exemplary embodiment, fuel injection assembly 126 extends from an end cover 140 of combustor 124 (shown in FIG. 1). A plurality of tube assemblies 202 are coupled within combustor 124 and each tube assembly 202 includes an upstream portion 156 and a downstream portion 158. In the exemplary embodiment, tube assemblies 202 are fuel injection nozzles that are each substantially axially coupled within combustor 124. Tube assemblies 202 may be formed integrally within combustor 124 or tube assemblies 202 may coupled to combustor 124. In the exemplary embodiment, each tube assembly 202 includes a plurality of tubes 204 that extend from upstream portion 156 to downstream portion 158. In the exemplary embodiment, each tube 204 discharges a mixture of fuel, air, and other fluids that are channeled through a passage (not shown) within each tube 204.

Fuel injection assembly 126 also includes at least one injection system 206. More specifically, in the exemplary embodiment, each tube assembly 202 is coupled to one injection system 206, and FIG. 2 illustrates three injection systems 206 that are coupled to three different tube assemblies 202. Injection system 206, in the exemplary embodiment, includes a fuel delivery pipe 208 and a fluid supply member 210 that is coupled to fuel delivery pipe 208 such that fluid supply member 210 substantially circumscribes at least a portion of fuel delivery pipe 208. Alternatively, fluid supply member 210 may be positioned in any other location with respect to fuel delivery pipe 208, such as adjacent to fuel delivery pipe 208, and that enables fuel injection assembly 126 and/or turbine engine 100 (shown in FIG. 1) to function as described herein.

In the exemplary embodiment, fluid supply member 210 has a substantially cylindrical shape and extends through end cover 140 and extends downstream from end cover 140 such that fluid supply member 210 is positioned a distance 216 from tube assembly 202. Moreover, in the exemplary embodiment, distance 216 between each fluid supply member 210 and respective tube assembly 202 is substantially similar. Alternatively, distance 216 between each fluid supply member 210 and respective tube assembly 202 may be substantially different from each other or vary in any other suitable arrangement. Alternatively, fluid supply member 210 may have any other shape and may extend to tube assembly 202 such that fluid supply member 210 may be coupled within tube assembly 202. In the exemplary embodiment, fluid supply member 210 includes a first portion 211 and a second portion 212, wherein first portion 211 extends from second portion 212. The size and/or diameter of first portion 211 is substantially larger than that of second portion 212. The size and/or diameter of first portion 211 may be substantially similar to tube assembly 202 such that the fluid can be delivered toward tube assembly 202. A fluid source 215 is coupled to fluid supply member 210. More specifically, in the exemplary embodiment, fluid source 215 is coupled to second portion 212. Fluid source 215 may include fuel, air, an inert gas, and/or a diluent, such as Nitrogen gas (N₂), Carbon Dioxide (CO₂), and/or steam. First portion 211, in the exemplary embodiment, includes at least one first opening (not shown in FIG. 2) for delivering fluid toward tube assembly 202.

Fuel delivery pipe 208, in the exemplary embodiment, includes a first end portion 220 that is coupled to tube assembly 202, a middle portion 221, and a second end portion 222 that is coupled to a fuel source (not shown). In the exemplary embodiment, fuel delivery pipe 208 has a substantially cylindrical shape. Alternatively, fuel delivery pipe 208 may have any other shape and/or size that enables fuel injection assembly 126 and/or turbine engine 100 to function as described herein.

Referring to FIG. 3.in the exemplary embodiment, first portion 211 of fluid supply member 210 includes an upstream portion 302 and a downstream portion 304 coupled to upstream portion 302 such that at least one channel 306 is defined therebetween. Moreover, first portion 211 also includes a side portion 301 that extends from upstream portion 302 to downstream portion 304. In the exemplary embodiment, side portion 301 is exterior portion of first portion 211 that substantially circumscribes at least a portion of fuel delivery pipe 208. In the exemplary embodiment downstream portion 304 is an effusion plate.

An impingement plate 308 is coupled between upstream portion 302 and downstream portion 304 such that a channel 310 is defined between upstream potion 302 and impingement plate 308, and a channel 312 is defined between impingement plate 308 and downstream portion 304. At least one first opening 320 is defined within and extends through downstream portion 304 and/or through side portion 301. At least one second opening 322 is defined within and extends through impingement plate 308.

During operation, fuel is channeled through fuel delivery pipe 208 and supplied to tube assembly 202, wherein the fuel is mixed with air to form a combustible mixture in tubes 204. For example, when fuel is supplied to tube assembly 202, fluids, such as air, inert gases, and/or diluents, such as N₂, CO₂, and/or steam are also supplied to tube assembly 202. More specifically, fluid is channeled from fluid source 215 through fluid supply member 210 to second portion 212. Fluid flows from second portion 212 to first portion 211, wherein fluid flows through channel 310 and through impingement plate 308 via second openings 322. Fluid flows through second openings 322 into channel 312. Fluid is then channeled through each first opening 320 and is delivered toward tube assembly 202. The fluid dilutes the combustion products recirculating flow pattern in the center area and the area around tubes 204, and the fluid dilutes the blended mixture in the tubes 204. More specifically, the fluid facilitates diluting the blended mixture and combustion products and reducing the flame interaction between tubes 204 and between adjacent tube assemblies 202. By substantially reducing such flame interactions, the temperature of tube assembly 202 is reduced, and the overall temperature of combustor 124 (shown in FIG. 1) is reduced. Further, by reducing the flame interactions within tube assembly 202 and between adjacent tubes 204, dynamic pressure oscillations within combustor 124 are reduced and NOx emission is also reduced by avoiding locally peak flame temperature formed through flame interactions between tubes 204. By substantially reducing such interactions and diluting all fluids within the combustor 124, the temperature of tube assembly 202 and dynamic oscillations therein are reduced, and the useful life of tube assembly 202 may be lengthened, as well as the useful life of combustor 124. Such a reduction in temperature may also facilitate a reduction in the production of oxides of nitrogen (NOₓ) by turbine engine 100 (shown in FIG. 1).

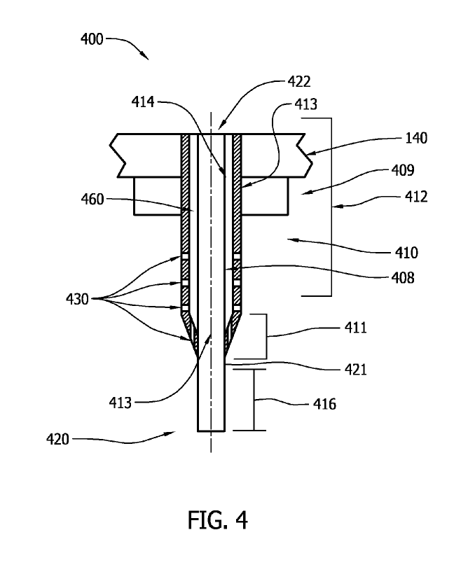

FIG. 4 is an enlarged schematic cross-sectional view of a portion of an alternative injection system 400 that may be used with fuel injection assembly 126 (shown in FIG. 2) and taken along area 4 in place of injection system 206. Injection system 400, in the exemplary embodiment, includes a fuel delivery pipe 408 and a fluid supply member 410 that is coupled to fuel delivery pipe 408 such that fluid supply member 410 substantially circumscribes at least a portion of fuel delivery pipe 408. Alternatively, fluid supply member 410 may be positioned in any other location with respect to fuel delivery pipe 408, such as adjacent to fuel delivery pipe 408, and that enables fuel injection assembly 126 and/or turbine engine 100 (shown in FIG. 1) to function as described herein.

In the exemplary embodiment, fluid supply member 410 has a substantially cylindrical shape and extends through end cover 140 (shown in FIG. 2) of combustor 124 (shown in FIG. 1) and through a tube assembly flange 409. Fluid supply member 410 extends downstream from end cover 140 and tube assembly flange 409 such that fluid supply member 410 is positioned a distance 416 from tube assembly 202 (shown in FIG. 2). Alternatively, fluid supply member 410 may have any other shape and may extend to tube assembly 202 such that fluid supply member 410 may be coupled within tube assembly 202.

In the exemplary embodiment, fluid supply member 410 includes a first portion 411 extending from a second portion 412. First portion 411 may be converged towards fuel delivery pipe 408 to substantially reduce the blockage of flowing air and any fluid that flows toward tube assembly 202. More specifically, in the exemplary embodiment, fluid source 215 (shown in FIG. 2) is coupled to second portion 412. Moreover, in the exemplary embodiment, fluid supply member 410 includes an exterior surface 413 and an opposing interior surface 414, wherein each of first portion 411 and second portion 412 include exterior surface 413 and interior surface 414.

Fuel delivery pipe 408, in the exemplary embodiment, includes a first end portion 420 that is coupled to tube assembly 202, a middle portion 421, and a second end portion 422 that is coupled to a fuel source (not shown). In the exemplary embodiment, fuel delivery pipe 408 has a substantially cylindrical shape. Alternatively, fuel delivery pipe 408 may have any other shape and/or size that enables fuel injection assembly 126 and/or turbine engine 100 to function as described herein. In the exemplary embodiment, interior surface 414 of fluid supply member 410 substantially circumscribes fuel delivery pipe 408. Fluid supply member 410 also includes at least one opening 430 that extends from exterior surface 413 to interior surface 414, and fluid supply member 410 channels fluid through channel 460 and through opening 430. More specifically, in the exemplary embodiment, fluid supply member 410 includes a plurality of openings 430 within first portion 411 and second portion 412. Alternatively, fluid supply member 410 may include at least one opening in either the first portion 411 or second portion 412. The openings 430 may be defined as an angle to uniformly distribute the fluid toward tube assembly 202.

As compared to known apparatus and systems that are used with turbine engines, the above-described fuel injection assembly may be used with turbine engines to facilitate substantially reducing the dynamic pressure oscillations and/or reducing NOx emission within a combustor. The fuel injection assembly includes a plurality of tube assemblies wherein each of the plurality of tube assemblies includes a plurality of tubes. At least one injection system is coupled to at least one tube assembly of the plurality of tube assemblies. The injection system includes a fluid supply member that is positioned a predefined distance upstream from the tube assembly. The fluid supply member includes a first portion that includes at least one first opening for delivering fluid toward the tube assembly for reducing dynamic pressure oscillations within a combustor and/or reducing NOx emission within the combustor during operation of the turbine engine. For example, as described above, the first portion of the fluid supply member may include an upstream portion and a downstream portion coupled to upstream portion such that at least one channel is defined therebetween. Moreover, the first portion may also include a side portion or exterior portion that extends from the upstream portion to the downstream portion, and that substantially circumscribes at least a portion of a fuel delivery pipe. The first opening may be defined within and extend through the downstream portion and/or through the side portion. At least one second opening may be defined within an impingement plate coupled between the upstream portion and the downstream portion. By delivering the fluid toward at least one of the tube assemblies, flame interactions within/or between the tube assemblies may be prevented, and the dynamic pressure oscillations and/or locally peak temperature, may be reduced therein. Such a reduction in temperature may also facilitate a reduction in the production of NOx emission by the turbine engine.

Exemplary embodiments of a fuel injection assembly and method of assembling same are described above in detail. The fuel injection assembly and method of assembling same are not limited to the specific embodiments described herein, but rather, components of the fuel injection assembly and/or steps of the injection assembly may be utilized independently and separately from other components and/or steps described herein. For example, the fuel injection assembly may also be used in combination with other machines and methods, and is not limited to practice with only a turbine engine as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel injection assembly for use in a turbine engine, said fuel injection assembly comprising:
a plurality of tube assemblies wherein each of said plurality of tube assemblies comprises a plurality of tubes; and
at least one injection system coupled to at least one tube assembly of said plurality of tube assemblies, wherein said at least one injection system comprises a fluid supply member that is positioned a predefined distance upstream from said at least one tube assembly, said fluid supply member comprises a first portion comprising at least one first opening for delivering fluid toward said at least one tube assembly for at least one of reducing dynamic pressure oscillations within a combustor and reducing NOx emission within the combustor during operation of the turbine engine.

2. A fuel injection assembly in accordance with claim 1, wherein said at least one injection system further comprises a fuel delivery pipe, said fluid supply member substantially circumscribes at least a portion of said fuel delivery pipe, said at least one fluid supply member comprises an exterior surface and an opposing interior surface that substantially circumscribes at least a portion of said fuel delivery pipe, said at least one first opening extends from said exterior surface to said interior surface.

3. A fuel injection assembly in accordance with claim 1, wherein said at least one injection system comprises:
a first injection system coupled to a first tube assembly and comprising a first fluid supply member positioned a first predefined distance upstream from said first tube assembly;
a second injection system coupled to a second tube assembly and comprising a second fluid supply member positioned a second predefined distance upstream from said second tube assembly; and
a third injection system coupled to a third tube assembly and comprising a third fluid supply member positioned a third predefined distance upstream from said third tube assembly, wherein the first predefined distance, the second predefined distance, and the third predefined distance are substantially different from each other.

4. A fuel injection assembly in accordance with claim 1, wherein said each of said plurality of tube assemblies is a fuel nozzle.

5. A fuel injection assembly in accordance with claim 1, wherein said first portion comprises:
an upstream portion;
a downstream portion coupled to said upstream portion such that at least one channel is defined therebetween, wherein said at least one first opening extends through said downstream portion; and
an exterior portion that extends from said upstream portion to said downstream portion.

6. A fuel injection assembly in accordance with claim 5, wherein said first portion comprises an impingement plate coupled between said upstream portion and said downstream portion such that the at least one channel includes a first channel defined between said upstream portion and said impingement plate and a second channel defined between said impingement plate and said downstream portion.

7. A fuel injection assembly in accordance with claim 5, wherein said first portion comprises at least one second opening extending through said impingement plate.

8. A fuel injection assembly in accordance with claim 1, further comprising a fluid source coupled to said fluid supply member, wherein said fluid source contains at least one of fuel, a diluent, an inert gas, and air to be delivered toward said at least one tube assembly.

9. A turbine engine, said turbine engine comprising:
a compressor; and
a combustion assembly coupled downstream from said compressor, wherein said combustion assembly comprises at least one combustor comprising a fuel injection assembly comprising:
a plurality of tube assemblies wherein each of said plurality of tube assemblies comprises a plurality of tubes; and
at least one injection system coupled to at least one tube assembly of said plurality of tube assemblies, wherein said at least one injection system comprises a fluid supply member that is positioned a predefined distance upstream from said at least one tube assembly, said fluid supply comprises a first portion comprising at least one first opening for delivering fluid toward said at least one tube assembly for at least one of reducing dynamic pressure oscillations within said combustor and reducing NOx emission within said combustor during operation of said turbine engine.

10. A turbine engine in accordance with claim 9, wherein said at least one injection system comprises a fuel delivery pipe, said fluid supply member substantially circumscribes at least a portion of said fuel delivery pipe, wherein said at least one fluid supply member comprises an exterior surface and an opposing interior surface that substantially circumscribes at least a portion of said fuel delivery pipe, said at least one first opening extends from said exterior surface to said interior surface.

11. A turbine engine in accordance with claim 9, wherein said at least one injection system comprises:
a first injection system coupled to a first tube assembly and comprising a first fluid supply member positioned a first predefined distance upstream from said first tube assembly;
a second injection system coupled to a second tube assembly and comprising a second fluid supply member positioned a second predefined distance upstream from said second tube assembly; and
a third injection system coupled to a third tube assembly and comprising a third fluid supply member positioned a third predefined distance upstream from said third tube assembly, wherein the first predefined distance, the second predefined distance, and the third predefined distance are substantially different from each other.

12. A turbine engine in accordance with claim 9, wherein said first portion comprises:
an upstream portion;
a downstream portion coupled to said upstream portion such that at least one channel is defined therebetween, wherein said at least one first opening extends through said downstream portion; and
an exterior portion that extends from said upstream portion to said downstream portion.

13. A turbine engine in accordance with claim 12, wherein said first portion comprises an impingement plate coupled between said upstream portion and said downstream portion such that the at least one channel includes a first channel defined between said upstream portion and said impingement plate and a second channel defined between said impingement plate and said downstream portion

14. A turbine engine in accordance with claim 13, wherein said first portion comprises at least one second opening extending through said impingement plate.

15. A turbine engine in accordance with claim 9, wherein said fuel injection assembly comprises a fluid source coupled to said fluid supply member, wherein said fluid source contains at least one of a diluent, an inert gas, fuel, and air to be delivered toward said at least one tube assembly.

16. A method for assembling a fuel injection assembly for use with a turbine engine, said method comprising:
providing a plurality of tube assemblies wherein each of the plurality of tube assemblies includes a plurality of tubes; and
coupling at least one injection system to at least one tube assembly of the plurality of tube assemblies, wherein the at least one injection system includes a fluid supply member that is positioned a predefined distance upstream from the at least one tube assembly, the fluid supply includes a first portion that includes at least one first opening for delivering fluid toward the at least one tube assembly for at least one of reducing dynamic pressure oscillations within a combustor and reducing NOx emission within the combustor during operation of the turbine engine.

17. A method in accordance with claim 16, further comprising coupling a fuel delivery pipe to the fluid supply member such that the fluid supply member substantially circumscribes at least a portion of the fuel delivery pipe.

18. A method in accordance with claim 16, wherein coupling at least one injection system to at least one tube assembly further comprises coupling at least one injection system that includes a fluid supply member that includes a first portion that includes an upstream portion, a downstream portion coupled to the upstream portion such that at least one channel is defined therebetween, wherein the at least one first opening extends through the downstream portion, and an exterior portion that extends from the upstream portion to the downstream portion.

19. A method in accordance with claim 18, wherein coupling at least one injection system to at least one tube assembly further comprises coupling at least one injection system that includes a fluid supply member that includes a first portion that includes an impingement plate coupled between the upstream portion and the downstream portion such that the at least one channel includes a first channel defined between the upstream portion and the impingement plate and a second channel defined between the impingement plate and the downstream portion.

20. A method in accordance with claim 16, wherein coupling at least one injection system further comprises:
coupling a first injection system to a first tube assembly, wherein the first injection system includes a first fluid supply member positioned a first predefined distance upstream from the first tube assembly;
coupling a second injection system to a second tube assembly, wherein the second injection system includes a second fluid supply member positioned a second predefined distance upstream from the second tube assembly; and
coupling a third injection system to a third tube assembly, wherein the third injection system includes a third fluid supply member positioned a third predefined distance upstream from said third tube assembly, wherein the first predefined distance, the second predefined distance, and the third predefined distance are substantially different from each other.
